(19) United States
(12) Patent Application Publication
(10) Pub. No.: US 2014/0170287 A1
(43) Pub. Date: Jun. 19, 2014

(54) METHODS FOR PREPARING AND COMPOSITIONS COMPRISING PLANT SEED-BASED OMEGA-3 FATTY ACIDS

(71) Applicant: Living Healthy World LLC, Everett, WA (US)

(72) Inventor: Orsalem Kahsai, Lynnwood, WA (US)

(21) Appl. No.: 14/109,638

(22) Filed: Dec. 17, 2013

Related U.S. Application Data
(60) Provisional application No. 61/738,162, filed on Dec. 17, 2012.

(51) Int. Cl. A23L 1/36; B02C 19/18

(52) U.S. Cl. CPC A23L 1/366; B02C 19/186
USPC 426/548; 426/629; 426/631; 426/633; 241/8

(57) ABSTRACT

Provided are methods for preparing, and compositions comprising, plant-based forms of omega-3 fatty acids and lignan, which methods and compositions are exemplified by methods for preparing roasted seed granules, including roasted flaxseed granules, and compositions that comprise one or more roasted seed granules that are prepared by roasting and grinding under specified conditions of temperature and time, as disclosed in detail herein, to enhance one or more desired properties including the digestibility and/or palatability of such seeds and/or the bioavailability and/or stability of omega-3 and other fatty acids that are constituents of those seeds.

### CROSS-REFERENCE TO RELATED APPLICATIONS

This application, which was filed as a U.S. non-provisional patent application on Dec. 17, 2013, claims the benefit of U.S. Provisional Patent Application No. 61/738,162, filed Dec. 17, 2012, which provisional patent application is incorporated by reference in its entirety.

### BACKGROUND OF THE DISCLOSURE

1. Technical Field of the Disclosure

The present disclosure relates, generally, to the field of nutraceuticals. More specifically, provided herein are methods for preparing, and compositions comprising, plant-based forms of omega-3 fatty acids and lignan, which methods and compositions are exemplified by methods for preparing roasted seed granules, including roasted flaxseed granules, and compositions that comprise one or more roasted seed granules that are prepared by roasting and grinding under specified conditions of temperature and time, as disclosed in detail herein, to enhance one or more desired properties including the digestibility and/or palatability of such seeds and/or the bioavailability and/or stability of omega-3 and other fatty acids that are constituents of those seeds.

2. Description of the Related Art

Flaxseed (a/k/a linseed), Linum usitatissimum, is a member of the genus Linum in the family Linaceae. Flaxseed is a food and fiber crop that is grown in cooler regions of the world. Flaxseeds, which are either brown or yellow/golden, contain high levels of dietary fiber as well as lignans, an abundance of micronutrients, and omega-3 fatty acids.

Lignans are a class of phytoestrogens considered to have antioxidant and cancer-preventing properties, although the extracted flaxseed oil does not contain the lignans found in the seed and does not have the same antioxidant properties. Initial studies suggest that flaxseeds taken in the diet may benefit individuals with certain types of breast and prostate cancers. Flaxseed may also lessen the severity of diabetes by stabilizing blood-sugar levels and may lower cholesterol levels.

Food-grade flaxseed oil is cold-pressed, obtained without solvent extraction, in the absence of oxygen, and marketed as edible flaxseed oil. Flaxseed oil is easily oxidized, and rapidly becomes rancid, with an unpleasant odor, unless refrigerated. Even when kept under cool conditions, it has a shelf life of only a few weeks. Oxidation of flaxseed oil is a major commercial concern, and antioxidants may be added to prevent rancidification.

Fresh, refrigerated, and unprocessed, flaxseed oil is used as a nutritional supplement and is a traditional European ethnic food. Flaxseeds are the richest commonly available seed source of the plant based omega-3 fatty acid alpha-linolenic acid (ALA) and are also a good source of omega-6 fatty acids (with 3:1 ratio of omega-3 to omega-6), omega-9 fatty acids, as well as lignan, fiber, various proteins, manganese, vitamin B, magnesium, tryptophan, phosphorus, and copper. The unsaturated omega-3 fatty acids are essential to the body by promoting the emulsification and, thereby, the in vivo absorption of the fat soluble vitamins, A, D, E, & K. Regular flaxseed oil contains between 52% and 63% ALA (C18:3n-3). Plant breeders have developed flaxseed with both higher ALA (70%) and very low ALA content (<3%). 14 g of flaxseed oil contains 8 g of omega-3, 2 g of omega-6, and 3 g of omega-9.

According to the Flax Council of Canada, ALA is required for normal infant development and may be beneficial for reducing inflammation leading to atherosclerosis, and for preventing heart disease and arrhythmia. However, recent well-controlled placebo studies suggest the regular consumption of flaxseed oil may not reduce the risk of stroke, heart disease, or cancer.

ALA in flaxseeds can be helpful to the cardiovascular system in and of itself. As the building block for other messaging molecules that help prevent excessive inflammation, ALA can help protect the blood vessels from inflammatory damage. For example, consumption of ALA in flaxseeds decreases by 10-15% the blood levels of C-reactive protein (CRP), a commonly used marker of the inflammatory status in the cardiovascular system.

Numerous studies have shown the capacity of dietary flaxseeds to increase blood levels of omega-3 fatty acids, such as ALA. When flaxseeds are consumed, two other omega-3 fatty acids also increase in the bloodstream, namely, eicosapentaenoic acid (EPA) and docosahexaenoic acid (DHA). Increases in blood levels of EPA and DHA also provide inflammatory protection. Flaxseeds do not contain EPA and DHA, but contain high levels of ALA, which is broken down enzymatically in vivo into EPA and DHA.

Fish is an exemplary food source that is high in EPA and DHA. Unfortunately, however, fish also frequently contain high levels of mercury and other contaminants, which are toxic to humans through, for example, the impairment of neurological development. The presence of these contaminants decreases the desirability of consuming large quantities of fish.

Humans can use ALA as a substrate for the in vivo generation of all required omega-3 fatty acids, including both EPA and DHA. Thus, the dietary intake of adequate quantities of ALA obviates the need for other sources of dietary omega-3 fatty acids. Moreover, the conversion of omega-3 fatty acids to EPA and DHA is regulated in vivo such that the body does not synthesize excessive quantities of EPA and DHA, which could occur through the dietary consumption of these fatty acids. Thus, the consumption of high levels of ALA in flaxseed does not lead to the overconsumption of EPA and DHA.

The consumption of flax seed by humans and other animals may provide several benefits for improving and maintaining general health. Flax seed is rich in dietary fiber, protein, and alpha-linolenic acid: an essential Omega-3 fatty acid. More than 70% of the lipid content of flaxseed may encompass polyunsaturated fats, with a high ratio of alpha-linolenic acid (an omega-3 fatty acid) to linolenic acid (an omega-6 fatty acid). The potential health benefits of increasing dietary intake of omega-3 fatty acids are well documented, and potentially include prophylaxis of disorders such as heart disease and cancer. Numerous other potential health benefits are also known.

Flaxseed has also been shown to decrease the ratio of LDL-to-HDL cholesterol in several human studies and to increase the level of apolipoprotein A1, which is the major protein found in HDL cholesterol (the “good” cholesterol). This HDL-related benefit may be partly due to the simple fiber content of flaxseeds.

Flaxseeds are also an excellent source of dietary lignans. This compound acts like a phytoestrogen and has been implicated in the prevention of some types of cancers, especially breast and colon cancers. Lignans are phytoestrogens, which act like the hormone estrogen. Lignans are unique fiber-related polyphenol that provides antioxidant benefits, fiber-like benefits, and also act as phytoestrogens. Flaxseeds are significantly higher in polyphenol antioxidants than other common vegetative food sources such as blueberries and olives. Among all commonly eaten foods, researchers generally consider flaxseed as the best source of lignans for human diets. The antioxidant benefits of flaxseeds have long been associated with prevention of cardiovascular diseases and have recently also been tied to decreased insulin resistance.

Flaxseeds offer many additional health benefits, which include maintaining bowel regularity, stabilizing blood sugar levels, and lowering blood cholesterol levels. Moreover, the viscous nature of soluble fibers, such as flaxseed mucilage, has been hypothesized to slow down digestion and absorption of starch, thereby reducing blood glucose levels as well as insulin and other endocrine responses.

Whole flaxseeds pass through the digestive system without being digested; the hull of the seed is hard to digest. Grinding flaxseeds is a good way to make some of the nutrients in this seed more accessible for absorption and, more importantly, helps the body absorb the omega-3 fatty acids. These polyunsaturated fats are, however, sensitive to oxygen, light, and heat, which make them particularly prone to oxidation and rancidity.

U.S. Pat. No. 7,344,747 describes oil-based food compositions in which omega-3 fatty acids are stabilized against oxidation and photodegradation. This patent also describes food products such as peanut butter, peanut spread, and peanut oil-containing food compositions wherein the alpha-linolenic acid (18:3) and other omega-3 fatty acids are exhibit improved oxidative stability.

U.S Patent Publication No. 2007/0196560 describes all natural omega enriched peanut butter and peanut butter spreads wherein a natural stabilizer is incorporated that forms a matrix with the peanut oil and peanut particles thereby resisting separation of peanut oil from the peanut particles.

U.S. Pat. No. 7,144,595 describes prepared foods containing triglyceride-recrystallized non-esterified phytosterols, which foods include an oxidation-resistant fat-based composition that is free of exogenous solubilizing and dispersing agents for phytosterols.

It is well known in the art that the taste of raw, untreated flaxseed can be unpleasant and that the consistency of raw flaxseed can make it difficult to chew, swallow, and/or digest. Raw, untreated flaxseed may be ground to a powdery consistency via a grinder (e.g., a coffee grinder or industrial scale grinder) and the taste of the raw flax seed masked as desired. Raw, untreated flaxseed is also rather difficult to handle. Once the seed has been broken, and the inner fleshy portions of the seed exposed to air, the flaxseed can exhibit poor stability and begin to degrade and decompose fairly quickly making it unsuitable for human consumption.

What is critically needed in the art are methods for producing and compositions comprising ground flaxseed having improved properties of digestibility while achieving decreased susceptibility to oxidation and rancidity. Such compositions could find widespread utility in a wide range of food products, thereby providing a unique opportunity to improve the dietary benefits of those food sources.

### SUMMARY OF THE DISCLOSURE

The present disclosure addresses these and other related needs in the art by providing, inter alia, methods for producing and compositions comprising a stable, plant-based form of fatty acids, in particular omega-3 fatty acids, including alpha-linolenic acid, omega-6 fatty acids, and omega-9 fatty acids.

Thus, within certain embodiments disclosed herein are methods for producing a stabilized plant-based source of omega-3 fatty acids, which methods comprise (1) roasting whole raw seed, including a flaxseed, a canola seed, a hemp seed, and/or a chia seed, wherein the seed contains a seed coat and a kernel, at suitable conditions of time and temperature to disrupt the structural integrity of the seed coat and (2) grinding the roasted ground seed under suitable conditions of temperature and final granule size to permit the release of omega-3 fatty acids when ingested, but without causing the separation of omega-3 fatty acids, and other fatty acids, from the remainder of the seed grain.

By these methods, raw seed is roasted at a temperature of from about 200° F. to about 400° F., or from about 225° F. to about 375° F., or from about 250° F. to about 350° F., or from about 275° F. to about 325° F. for a time of from about 1 minutes to about 7 minutes, or from about 2 minutes to about 6 minutes, or from about 3 minutes to about 5 minutes. The roasted seed is ground at a temperature from about 55° F. to about 80° F., or from about 60° F. to about 75° F., or from about 65° F. to about 70° F. to a final granule size of from about 0.1 mm to about 0.6 mm, or from about 0.2 mm to about 0.5 mm, or from about 0.3 mm to about 0.4 mm.

Within other embodiments disclosed herein are compositions comprising ground, roasted seed, including roasted flaxseed, canola seed, hemp seed, and/or chia seed, wherein the roasting and grinding are performed according to the presently disclosed methods. For example, provided are compositions comprising ground, roasted seed that is produced by (1) roasting whole raw seed at suitable conditions of time and temperature to disrupt the structural integrity of the seed coat and (2) grinding the roasted ground seed under suitable conditions of temperature and final granule size to permit the release of omega-3 fatty acids when ingested, but without causing the separation of omega-3 fatty acids, and other fatty acids, from the remainder of the seed grain.

Such compositions comprise ground, roasted seed, including roasted flaxseed, canola seed, hemp seed, and/or chia seed, wherein the seed was roasted at a temperature of from about 200° F. to about 400° F., or from about 225° F. to about 375° F., or from about 250° F. to about 350° F., or from about 275° F. to about 325° F. for a time of from about 1 minutes to about 7 minutes, or from about 2 minutes to about 6 minutes, or from about 3 minutes to about 5 minutes and wherein the roasted seed is ground at a temperature from about 55° F. to about 80° F., or from about 60° F. to about 75° F., or from about 65° F. to about 70° F. to a final granule size of from about 0.1 mm to about 0.6 mm, or from about 0.2 mm to about 0.5 mm, or from about 0.3 mm to about 0.4 mm.

Within certain aspects of these embodiments, the present disclosure provides compositions comprising ground, roasted seed, including roasted flaxseed, canola seed, hemp seed, and/or chia seed, wherein the seed was roasted at a temperature of from about 250° F. to about 350° F. for a time of from about 3 minutes to about 5 minutes and wherein the roasted seed was ground at a temperature from about 65° F. to about 70° F. to a final granule size of from about 0.1 mm to about 0.6 mm.

Within yet further embodiments disclosed herein are compositions comprising roasted and ground roast seeds, including roasted and ground flaxseeds, canola seeds, hemp seeds, and/or chia seeds, wherein the roasting and grinding are performed according to the presently disclosed methods, which compositions further comprise one or more food source selected from the group consisting of a nut butter or nut-containing spread, a seed butter or seed-containing spread, a vegetable oil or product containing a vegetable oil, an animal fat or a product containing an animal fat, a salad dressing, a fruit spread, a vegetable spread, a fruit and vegetable spread, a fruit- and/or a vegetable-containing beverage, such as a fruit- and/or vegetable-containing smoothy, a chocolate spread, and a food bar such as a granola bar or an energy bar.

Suitable nut butters can be selected from the group consisting of almond butter, peanut butter, cashew butter, hazelnut butter, macadamia nut butter, pecan butter, and walnut butter. Suitable seed butters can be selected from the group consisting of safflower seed butter, sunflower seed butter, pumpkin seed butter, sesame seed butter, chia seed butter, soy seed butter, chia seed butter, hemp seed butter, and rapeseed butter. Suitable vegetable oils can be selected from the group consisting of peanut oil, safflower oil, sunflower oil, pumpkin seed oil, sesame seed oil, soy seed oil, chia seed oil, hemp seed oil, rapeseed oil, butternut oil, pecan oil, walnut oil, hazelnut oil, almond oil, cashew oil, macadamia nut oil, corn oil, olive oil, palm oil, coconut oil, flaxseed oil, and canola oil. Suitable animal fats can be selected from the group consisting of beef fat, pork fat, poultry fat, fish fat, lard, and butter.

Nut butter and seed butter compositions may, optionally, also include one or more concentrated fruits and/or vegetables for additional nutrition. Nut butter, seed butter, and granola bar compositions may, optionally, also include one or more mixed tocopherols, flavorings, salts, and/or nutritive enhancers.

Within certain aspects of these embodiments, the present disclosure provides compositions comprising roasted and ground seeds, including roasted and ground flaxseeds, canola seeds, hemp seeds, and/or chia seeds, wherein the roasting and grinding are performed according to the presently disclosed methods further comprising one or more of a first food source selected from the group consisting of a nut butter, a vegetable oil, an animal fat, a salad dressing, and chocolate and one or more of a second food source selected from the group honey, molasses, corn syrup, cane syrup, and agave.

For example, the present disclosure provides compositions comprising from about 40% (v/v) to about 80% (v/v) of a roasted and ground seeds including roasted and ground flaxseeds, canola seeds, hemp seeds, and/or chia seeds, wherein the roasting and grinding are performed according to the presently disclosed methods; from about 10% (v/v) to about 30% (v/v) of palm oil and/or rapeseed/canola oil; and from about 10% (v/v) to about 30% (v/v) of a food source selected from the group consisting of honey, molasses, corn syrup, cane syrup, and agave.

For example, the present disclosure provides compositions comprising from about 5% (v/v) to about 20% (v/v) of a roasted and ground seeds including roasted and ground flaxseeds, canola seeds, hemp seeds, and/or chia seeds, wherein the roasting and grinding are performed according to the presently disclosed methods; from about 5% (v/v) to about 15% (v/v) of palm oil; and from about 5% (v/v) to about 15% (v/v) of a food source selected from the group consisting of honey, molasses, corn syrup, cane syrup, and agave; and from about 50% to about 85% of a nut butter or chocolate.

Within related embodiments, the present disclosure provides compositions comprising roasted and ground seeds including roasted and ground flaxseeds, canola seeds, hemp seeds, and/or chia seeds, wherein the roasting and grinding are performed according to the presently disclosed methods, which compositions further comprise a powdered grain meal selected from the group consisting of an oat meal, a bran meal, and a corn meal; a sweetener selected from the group consisting of a sugar and a polyol; and a powder selected from the group consisting of a milk powder, a coffee powder, an instant drink powder, a chocolate powder, and a nut powder. Such nut powders can, for example, include a peanut powder, a pecan powder, a walnut powder, a hazelnut powder, an almond powder, a butternut powder, a hazelnut powder, a cashew powder and a macadamia nut powder.

For example, the present disclosure provides compositions comprising from about 15% (v/v) to about 35% (v/v) of a roasted and ground flaxseeds, canola seeds, hemp seeds, and/or chia seeds, wherein the roasting and grinding are performed according to the presently disclosed methods; from about 15% (v/v) to about 35% (v/v) of a powdered grain meal selected from the group consisting of oat meal, bran meal, and corn meal; from about 15% (v/v) to about 35% (v/v) of a sweetener selected from the group consisting of a sugar and a polyol; and from about 15% (v/v) to about 35% (v/v) of a powder selected from the group consisting of a milk powder, coffee powder, an instant drink powder, a chocolate powder, and a nut powder.

For example, the present disclosure provides compositions comprising about 25% (v/v) of a roasted and ground flaxseeds, canola seeds, hemp seeds, and/or chia seeds, wherein the roasting and grinding are performed according to the presently disclosed methods; about 25% (v/v) of oat meal; about 25% (v/v) sugar; and about 25% (v/v) of milk powder, coffee powder, instant drink powder, chocolate powder, or nut powder.

For example, the present disclosure provides compositions comprising about roasted and ground flaxseeds, canola seeds, hemp seeds, and/or chia seeds, wherein the roasting and grinding are performed according to the presently disclosed methods; about 25% (v/v) of coffee powder; about 25% (v/v) sugar; and about 25% (v/v) of milk powder, instant drink powder, chocolate powder, or nut powder.

### DETAILED DESCRIPTION OF THE DISCLOSURE

The present disclosure is directed, generally, to methods for producing and seed-based compositions comprising a stable, plant-based form of fatty acids, in particular omega-3 fatty acids, including alpha-linolenic acid (ALA), omega-6 fatty acids (with 3:1 ratio omega-3 to omega-6), and omega-9 fatty acids. The seed-based compositions, including the flaxseed-based compositions, can further contain fiber, proteins, lignans and other nutritional components. The methods presented herein achieve improved properties of flaxseed including, without limitation, enhanced flavor properties, increased bio-availability of nutrients, sterilization, reduced content of moisture and thiocyanate.

These aspects of the present disclosure will be better understood in view of the following definitions:

### DEFINITIONS

As used herein, the term “seed” refers to a small embryonic plant enclosed in a covering referred to herein as a “seed coat,” which encompasses a “kernel” the includes an embryo and a supply of nutrients for the embryo. “Seeds” are products of the ripened ovule of gymnosperm and angiosperm plants that occurs after fertilization and some growth within the mother plant. The embryo is an immature plant from which a new plant will grow under proper conditions. Within a “seed” is a store of nutrients for the seedling that will grow from the embryo. The form of the stored nutrition varies depending on the kind of plant. The “seed coat” in a mature seed can be paper-thin layer (e.g., peanut) or thick and hard (e.g., flaxseed, canola seed, hemp seed, and chia seed). The seed coat helps protect the embryo from mechanical injury and from drying out.

Certain “seeds,” as exemplified herein by flaxseeds, canola seeds, hemp seeds, and chia seeds, contain within the “kernel” a high level of omega-3, omega-6, and other fatty acids. “Flaxseed” refers to the seed of the plant Linum usitatissimum. In its raw state, flax seeds are approximately 1 mm to 5 mm in diameter and contain a seed coat, which encompasses the kernel, which include the embryo and supply of nutrients. “Canola seed” or “rapeseed” refers to the seed of the plant Brassica napus), also known as rape, oilseed rape, rapa, rappi, rapaseed, which is a bright yellow flowering member of the family Brassicaceae (mustard or cabbage family). “Canola seed”/“rapeseed” is the third largest source of vegetable oil in the world. “Hemp seed” refers to the seed of the plant Cannabis sativa, which is an annual herbaceous plant in the Cannabis genus, a species of the Cannabaceae family. Cannabis sativa is a common source of industrial fiber, seed oil, food, and medicine and is used in hemp seed foods, hemp oil, wax, resin, rope, cloth, pulp, paper, and fuel. “Chia seed” refers to the seed of the plant Salvia hispanica, which is a species of flowering plant in the mint family, Lamiaceae. Chia seeds are in common use dietarily in Mexico and Guatemala, sometimes with the seeds ground or with whole seeds used for nutritious drinks and as a food source.

As used herein, the term “omega-3 fatty acid” refers to fats that are commonly found in marine and plant oils. Omega-3 fatty acids are polyunsaturated fatty acids with a double bond (C═C) starting after the third carbon atom from the end of the carbon chain. The fatty acids have two ends—the acid (COOH) end and the methyl (CH₃) end. The location of the first double bond is counted from the methyl end, which is also known as the omega (w) end or the n end. Omega-3 fatty acids are considered essential fatty acids; they cannot be synthesized by the human body but are vital for normal metabolism. Though mammals cannot synthesize omega-3 fatty acids, they have a limited ability to form the long-chain omega-3 fatty acids including eicosapentaenoic acid (EPA, 20 carbons and 5 double bonds), docosahexaenoic acid (DHA, 22 carbons and 6 double bonds) and α-linolenic acid (ALA, 18 carbons and 3 double bonds). Common sources of omega-3 fatty acids include fish oils, algal oil, squid oil, and plant oils such as echium oil and flaxseed oil.

As used herein, the term “about” encompasses a suitable and acceptable error associated with monitoring and/or measuring devices used in the field and further encompasses a suitable variation provided that utility of the embodiment is maintained.

It will be understood that, unless indicated to the contrary, terms intended to be “open” (e.g., the term “including” should be interpreted as “including but not limited to,” the term “having” should be interpreted as “having at least,” the term “includes” should be interpreted as “includes but is not limited to,” etc.). Phrases such as “at least one,” and “one or more,” and terms such as “a” or “an” include both the singular and the plural.

It will be further understood that where features or aspects of the disclosure are described in terms of Markush groups, the disclosure is also intended to be described in terms of any individual member or subgroup of members of the Markush group. Similarly, all ranges disclosed herein also encompass all possible sub-ranges and combinations of sub-ranges and that language such as “between,” “up to,” “at least,” “greater than,” “less than,” and the like include the number recited in the range and includes each individual member.

All references cited herein, whether supra or infra, including, but not limited to, patents, patent applications, and patent publications, whether U.S., PCT, or non-U.S. foreign, and all technical and/or scientific publications are hereby incorporated by reference in their entirety.

While various embodiments have been disclosed herein, other embodiments will be apparent to those skilled in the art. The various embodiments disclosed herein are for purposes of illustration and are not intended to be limiting, with the true scope and spirit being indicated by the claims.

### Methods for Producing Stabilized Plant-Based Source of Omega-3 Fatty Acids

The present disclosure is based, in part, upon the discovery that many of the limitations of certain raw seeds, including raw flaxseeds, canola seeds, hemp seeds, and chia seeds, in particular unpleasant flavor and other palatability characteristics, the poor digestibility, and limited bioavailability of constituent omega-3 and other fatty acids can be overcome by roasting seeds under suitable conditions of temperature and time followed by grinding or milling under suitable conditions of temperature to a specified granule size to achieve roasted and ground/milled seeds that exhibit highly desirable flavor characteristics, increased digestibility, and improved bioavailability of the constituent omega-3 and other fatty acids.

While the present disclosure exemplifies methods for producing stabilized flaxseed-based sources of omega-3 and other fatty acids, it will be understood that the present methods may be adapted by those skilled in the art to other seed-based sources of omega-3 and other fatty acids such as, for example, canola seeds, chia seeds, and hemp seeds, which also contain substantial quantities of omega-6 and omega-3 fatty acids at ratios of omega-6:omega-3 fatty acids of 2:1 for canola seeds, 2-3:1 for hemp seeds, which is in contrast to the 1:3 omega-6:omega-3 fatty acid ratio in flaxseeds and chia seeds.

Within certain embodiments, the present disclosure provides methods for producing stabilized plant-based sources of omega-3 fatty acids, which methods comprise (1) roasting a whole raw seed, such as a raw flaxseed, canola seed, hemp seed, or chia seed, the whole raw seed having a seed coat and a kernel that contains one or more omega-3 fatty acids, for a suitable and at a suitable temperature to disrupt the structural integrity of the seed coat and (2) grinding/milling the roasted whole seed at a suitable temperature to a final granule size to (a) prevent the separation of the omega-3 fatty acid and/or other fatty acid from the roasted seed grain and (b) increase the digestibility of the seed and/or the bioavailability of the omega-3 fatty acid.

More specifically, and as disclosed herein, seeds, such as a raw flaxseeds, canola seeds, hemp seeds, or chia seeds, which are: (1) roasted at a temperature of from about 200° F. to about 400° F., or from about 225° F. to about 375° F., or from about 250° F. to about 350° F., or from about 275° F. to about 325° F. for a time of from about 1 minutes to about 7 minutes, or from about 2 minutes to about 6 minutes, or from about 3 minutes to about 5 minutes and (2) ground/milled at a temperature from about 55° F. to about 80° F., or from about 60° F. to about 75° F., or from about 65° F. to about 70° F. to a final granule size of from about 0.1 mm to about 0.6 mm, or from about 0.2 mm to about 0.5 mm, or from about 0.3 mm to about 0.4 mm exhibits those highly desirable flavor and/or mouth-feel characteristics as well as increased digestibility and/or improved bioavailability of the constituent omega-3 and other fatty acids. Moreover, flaxseed that is roasted and ground according to the methods of the present disclosure comprises a reduced water content, an increased stability, and therefore shelf-life, of its constituent omega-3 and other fatty acids, and has substantially less contamination with mold, fungal, and/or bacterial contaminants.

### Methodology for Roasting Flaxseed and Other Seed-Based Sources of Omega-3 Fatty Acids

Various methodology have been described for roasting raw seeds, including raw flaxseed, canola seed, hemp seed, and chia seed, which may be advantageously adapted by those of skill in the art for use in the methods of the present disclosure. These methodology are exemplified by technology for roasting coffee beans such as, for example, European Patent Publication No. 055,462, which describes a methodology and device for roasting coffee beans by suspending and revolving the beans in a column of air having a controlled temperature and flow, and Canadian Patent No. 1,201,006, which describes an apparatus for roasting small quantities of coffee beans that includes a roasting chamber and an inlet orifice extending into the chamber for streaming hot roasting gas into the chamber, thereby generating a toroidal circulation of the coffee beans for even roasting thereof.

Seeds can also be roasted via fluidized bed technology as described in U.S. Pat. Nos. 4,109,394 and 4,419,834. More specifically, the '394 patent describes a system that may be adapted for roasting flaxseed, which system includes a conveyor for transporting particulate material through a treatment zone, a gas flow system for placing the particles on the conveyor in a fluidized condition as they pass through the treatment zone, and means along the side of the treatment zone for projecting a gaseous stream inwardly along the transport surface of the conveyor to provide a boundary sheath gas flow along the edge of the treatment zone.

The '834 patent describes a fluidized bed apparatus comprising a foraminous support (such as a perforate plate or screen), a fluidizing gas supply beneath the support, and a plurality of moveable flights above the support adapted to sweep the fluidized material along the support. The apparatus is especially adaptable by the skilled artisan for heat treating processes such as ing, toasting, roasting, and freezing of particulate food materials.

Other suitable roasting methodology are provided by Ikebudu et al. “Grain conditioning for dehulling of canola”, Canadian Agricultural Engineering 42(1):4.1-4.13 (2000), which describes various methodology for roasting oilseeds, such as canola seeds, prior to dehulling, which can be adapted to the presently-disclosed methods, which employ controlled roasting conditions to achieve the limited disruption of the structural integrity of a seed coats. Ikebudu describes, for example, the moistening of a seed to about 15% moisture content for 10 minutes followed by heating for about 5 minutes at about 160° F. to about 170° F. or to about 250° F. It will be understood, however, that these conditions of time and temperature may be modified for the roasting of seeds according to the conditions disclosed herein to achieve the desirable properties of flavor, digestibility, bioavailability, stability, and/or sterility. Canadian Patent No. 2,167,951 describes a methodology employing a heated fluidized bed for dehulling flaxseed, which methodology comprises ing flaxseed, breaking the dried flaxseed (e.g., by milling or grinding), and fractionating by air classification.

Such methodology for dehulling are described for the separation of a seed into a hull fraction (containing lignans and flaxseed gum) and a kernel fraction (containing proteins and fatty acids, including omega-3 fatty acids), which is not contemplated by the methods of the present disclosure. In contrast to those methodology, the presently disclosed methods were developed specifically to achieve the limited disruption of a hull fraction—to an extent required to provide improved digestibility and bioavailability of omega-3 and other fatty acids—without separating the disrupted hull fraction from the kernel fraction. It is well known in the art that flaxseed is sensitive to roasting processes, that flaxseed exhibits a fine grain, and that the components of flaxseed, including omega-3 fatty acids, are highly susceptible to degradation upon exposure to roasting conditions. Thus, the roasting conditions of time and temperature that are disclosed herein were developed to enhance properties of flavor, mouth-feel, digestibility, and bioavailability while minimizing the degradation of the constituent fatty acids, in particular the omega-3 fatty acids.

U.S. Patent Publication No. 2008/0274247 discloses fluidized bed methodology for the production of roasted oil seeds, including flaxseed, which methodology employs (1) heating an oil seed at a temperature of from about 265° F. to about 400° F. in less than about two minutes to produce a heated oil seed; (2) maintaining the heated oil seed at a sufficient temperature and for a sufficient time to produce a roasted oil seed; and (3) cooling the roasted oil seed. Heated air can be circulated around and interspersed between the seed thereby suspending the seed in air such that the entire surface area of each seed is uniformly exposed to the heating temperatures.

It will be understood that the conditions described in the '247 publication may be varied, as appropriate, to achieve the roasting conditions of the presently disclosed methods, which include roasting at a temperature of from about 200° F. to about 400° F., or, preferably, from about 225° F. to about 375° F., or, more preferably, from about 250° F. to about 350° F., or, most preferably, from about 275° F. to about 325° F. for a time of from about 1 minutes to about 7 minutes, or, preferably, from about 2 minutes to about 6 minutes, or, more preferably, from about 3 minutes to about 5 minutes.

Fluidized bed systems may be employed to achieve the desired roasting and conditions of the present disclosure. Suitable fluidized bed systems include the Jetzone® fluidized bed systems of Wolverine Procter (Lexington, N.C.), which generate high-velocity air jets from elongated jet-tubes. The air jets may be adjusted to deflect off a conveyor that moves the flaxseed through the system and lifts/tumbles the seeds. Jets are typically cylindrical tubes that direct a stream of air onto the flaxseed thereby generating fluidized bed conditions. Other suitable fluidized bed systems include the fluid bed driers available from Labline Instruments such as, for example, Labline Model Nos. 23350 and 23852 (Melrose Park, Ill.). See, e.g., Rantanen et al., “Next Generation Fluidized Bed Granulator Automation,” AAPS PharmSciTech 1(2):26-36 (2000).

### Methodology for Grinding Sseeds, Including Flaxseeds, and Other Seed-Based Sources of Omega-3 Fatty Acids

As disclosed herein, following the roasting process, seeds, including flaxseeds, canola seeds, hemp seeds, and chia seeds, are next subjected to grinding under suitable conditions of temperature to achieve roasted seed granules of a desired size, which was developed to enhance digestibility and bioavailability of ingested roasted seeds, to improve flavor and mouth-feel of roasted seeds and compositions containing roasted seeds, and to minimize the separation of omega-3 and other fatty acids from the roasted seed kernel, which ensures greater fatty acid stability and, as a consequence, longer shelf lives for such roasted ground seed granules as well as compositions containing such roasted ground seed granules as compared to conventional seed products as are currently available in the art.

More specifically, it was discovered as part of the present disclosure that roasted seeds, such as a raw flaxseeds, canola seeds, hemp seeds, or chia seeds, can be ground at a temperature from about 55° F. to about 80° F., or from about 60° F. to about 75° F., or from about 65° F. to about 70° F. to a final granule size of from about 0.1 mm to about 0.6 mm, or from about 0.2 mm to about 0.5 mm, or from about 0.3 mm to about 0.4 mm to achieve roasted seed granules that exhibit enhanced digestibility and bioavailability when ingested, improved flavor and/or mouth-feel, with minimal separation of omega-3 and other fatty acids from the roasted seed kernel. As used herein, 0.1 mm is approximately equivalent to No. 140 mesh, 0.2 mm is approximately equivalent to a No. 70 mesh, 0.3 mm is approximately equivalent to a No. 50 mesh, 0.4 mm is approximately equivalent to a No. 40 mesh, 0.5 mm is approximately equivalent to a No. 35 mesh, and 0.6 mm is approximately equivalent to a No. 30 mesh.

Seeds can be ground according the methods disclosed herein by employing methodology as is described in and readily available to those of skill in the art such as, for example, the methodology described in Canadian Patent Application No. 2,167,951. Because of the roasting conditions employed in the methods of the present disclosure, the ground or milled seeds contain both hulls (i.e., seed coats) and embryos (kernels), which are not separated by the grinding/milling process.

Seeds that have been roasted as disclosed herein can be ground or milled mechanically by, for example, a rubbing and/or friction mechanism such as, for example, by employing a Barley Pearler (available, e.g., from Strong-Scott Ltd, Winnipeg, Manitoba), by which the flat roasted flaxseeds are gently rubbed against a stone. Roasted seeds can be introduced into a Barley Pearler at a rate of approximately 100 g seeds/min.

Roasted seeds can also be ground/milled (1) in batch with a Technilab Micromill (Technilab Instruments, Pequannock, N.J.) such as, for example, at approximately 20 g flaxseed per batch, for approximately 10 seconds; (2) with a Stein Laboratory Mill (e.g., Model M-2, Atchison, Kans.) at, for example, approximately 50 g of roasted flaxseed milled/ground per batch for approximately 10 seconds; or (3) with a Thomas Wiley Mill (e.g., Model 4, 2 mm sieve, Thomas Scientific, USA) where the roasted seed can be introduced, for example, at approximately 100 g flaxseed/min using a 2 mm sieve.

Regardless of the precise methodology employed to grind/mill the roasted seed and/or the mass of roasted flaxseed ground/milled in a given period of time, it will be understood that grind/mill conditions to achieve roasted seed granules according to the presently disclosed methods are performed at a temperature of from about 55° F. to about 80° F., or from about 60° F. to about 75° F., or from about 65° F. to about 70° F. and under conditions that ensure that the final granule size be from about 0.1 mm to about 0.6 mm, or from about 0.2 mm to about 0.5 mm, or from about 0.3 mm to about 0.4 mm. The mix of ground/milled roasted seed can be fractionated to collect those roasted seed granules having a size of from about 0.1 mm to about 0.6 mm, or from about 0.2 mm to about 0.5 mm, or from about 0.3 mm to about 0.4 mm.

By following such conditions of temperature and granule size during the grinding/milling of roasted seed, the separation of husks and kernels and the production of exudate oil, which contains omega-3 and other fatty acids, are minimized thereby achieving the desired properties of increased digestibility of the roasted and ground seed granules, the bioavailability of the omega-3 and other fatty acids within the roasted and ground seed kernels, and increasing the stability of those omega-3 and other fatty acids, which, thereby, increases the shelf life of such roasted flaxseed granules and of compositions comprising those roasted flaxseed granules.

### Methodology for Assessing Water and Nutritional Content of Roasted Flaxseed Granules, Including Omega-3 Fatty Acid Content and Stability

Moisture and total solids content, ash, protein analysis, vitamin analysis, lipid (fatty acid) analysis, carbohydrate analysis, and secondary metabolites and nutraceuticals can be determined according to methodologies developed and/or validated by the Association of Official Analytical Chemists (AOAC®, 1980), as described in Nielsen, “Food Analysis” (3^{rd} edition, Kluwer, 2003), and according to the ASAE Standard 5352.2, “Moisture measurement Unground Grain and Seeds” (In ASAE Standards 44th Edition, 555. St. Joseph, Mich., 1997).

It is well known in the art that the moisture content of a food product, such as a seed that is roasted and ground/milled according to the presently-disclosed methods, affects both the stability of the roasted seed granules and the assessment of its nutritional content. Water can, for example, be free, adsorbed to cell walls or proteins, or present as a protein hydrate. To determine the water (moisture) content of, for example, raw vs. roasted seed, an oven drier (such as available from Blue M Electric Company, Illinois, USA), a rotatable microwave oven (such as a 900 w microwave oven as available from General Electronics, Canada), or a fluid bed drier (such as the Lab-line Model 23350) can be employed to dehydrate a sample and the moisture content of seed samples can be determined using a moisture meter such as, for example, Model Marr I, which is available from Denver Instrument Co. (Denver, Colo.).

Excellent nutritional content, including a high content of omega-3 to omega-6 fatty acids, can be achieved for roasted and ground/milled seed granules generated according to the present methodology. The content of omega-3 and other fatty acids in seed that are roasted and ground/milled according to the methods of the present disclosure can be determined by methodology that is readily available to and adaptable by those of skill in the art. Samples of raw and roasted seed can, for example, be analyzed by gas liquid chromatography according to standard methodology as prescribed by the AOAC in “Official Methods of Analysis of AOAC International” (18^{th} ed., 2005) and by employing techniques described in Manuals of Food Quality Control, FAO Food and Nutrition Paper 14:7 (1986).

The fatty acid content of seed samples can be determined, such as the relative amounts of C12, C14, C16, and C18 fatty acids. Seed samples can also be submitted to independent analysis as provided, for example, by Sun West™ Food Laboratory Ltd. (Saskatoon, SK, Canada). Crude oil content of flaxseeds can be determined by the method of Appelquist, J. Amer. Oil Chem. Soc. 44:209-214 (1967) and protein levels can be determined as described in Mazza and Biliaderis, “Functional Properties of Flaxseed Mucilage,” J. Food Sci. 54:1302-1305 (1989).

It is well known in the art that whole flaxseeds are chemically stable, but that ground flaxseed is susceptible to rancidity at room temperature and when included in compositions containing one or more additional components. The stability of roasted flaxseed granules prepared according to the presently-disclosed methods can be assessed by methodology available in the art.

Chen et al., “Stability of Flaxseed during Baking,” J. Am. Oil Chem. Soc. 71:629-632 (1992) describes methodology for assessing the stability of alpha-linolenic acid (ALA) in whole flaxseed, milled flaxseed, and extracted flax oil held in individual sealed glass tubes for 280 days (i.e., approximately 10 months) at room temperature with 12 hours alternating dark/light cycles. Ratnayake et al., “Flaxseed: Chemical Stability and Nutritional Properties,” J. Nutr. Biochem. 3:232-240 (1992) describes methodology for assessing the stability of whole and ground flaxseed after stored for 44 weeks (i.e., approximately 10 months) at 39° F. and at 72° F. Malcolmson et al., “Storage Stability of Milled Flaxseed,” J. Am. Oil Chem. Soc. 77(3):235-238 (2000) describes methodology for assessing the stability of milled flaxseed at 73° F. for 128 days (i.e., approximately 4 months) in paper bags with plastic liners. Samples were evaluated at 0, 33, 66, 96, and 128 days for chemical, sensory and volatile indicators of quality. Daun, “Additional Data on the Storage Stability of Milled Flaxseed,” J. Am. Oil Chem. Soc. 78(1):105-106 (2001) describes methodology for assessing the stability of milled flaxseed, which is packaged in loosely closed plastic bags and protected from light and stored in warehouse conditions at room temperatures for up to 20 months. Wiesenborn et al., “Mechanical Fractionation of Flaxseed for Edible Uses,” Proc. 59th Flax Inst. U.S. 25-29 (2002) describes methodology for assessing the stability of milled flaxseed exposed in the dark to air for 22 weeks at 104° F. and milled flaxseed stored in the dark in closed containers (plastic bags within paper bags) for 22 weeks at room temperature.

Muir et al., “Quantitation of the Lignan Secoisolariciresinal Diglucoside (SDG) in baked goods containing flaxseed or flaxmeal.” Proc. 56th Flax Inst. U.S. 81-85 (1996) describes the stability SDG in flaxbread, white bread, whole wheat bread, flax muffins, flax bagels, and flax cookies. Nesbitt and Thompson, “Lignans in Homemade and Commercial Products Containing Flaxseed.” Nutr. and Cancer 29:222-227 (1997) describe the stability of lignans in foods including raw flaxseed, homemade products containing flaxseed, and commercial breads and breakfast cereals with and without flaxseed that were subjected to an in vitro fermentation designed to simulate the colonic environment necessary for the conversion of plant precursors to mammalian lignans.

### Methodology for Assessing the Microbial Content of Roasted Seed Granules

It is well known in the art that seeds, including flaxseeds, canola seeds, hemp seeds, and chia seeds, are frequently contaminated with one or more pathogenic molds and/or yeasts (fungi), which can lead to deterioration of the flaxseed and are considered a serious health concern in many health and food science disciplines as well as consumer markets. Common flaxseed brands that are sold in retail supermarkets often have mold levels high enough to be considered unfit for human consumption.

In particular, one serious hazard associated with mold growth in foods is the possible production of mycotoxins, substances which are toxic, potentially carcinogenic, and may adversely affect immune systems. Mycotoxigenic molds and yeasts include, for example, toxic Aspergillus, Penicillium, and Fusarium species. At least 300 different mycotoxins can contaminate cereal grains and oil seeds.

Mycotoxin contamination of foodstuffs is the result of uncontrolled growth of certain toxigenic molds. Mycotoxins are highly toxic metabolic by-products, released into the immediate environment as these molds grow. As time proceeds, the molds responsible for the production of the mycotoxins may become non-viable. However, in most cases the mycotoxins remain due to their high chemical stability.

One of the advantages provided by the methods for producing roasted seed granules of the present disclosure is that various pathogenic molds and yeasts that commonly grow on seeds, including flaxseeds, canola seeds, hemp seeds, and chia seeds, are destroyed by the roasting process.

Given the relevance and importance of mold growth to mycotoxin contamination of seeds, including flaxseeds, canola seeds, hemp seeds, and chia seeds, it is important that assay systems be employed to ensure that such mycotoxigenic molds are killed by the roasting process. Accurate measurement of mold growth in an amorphous substrate, such as a seed, is less straight forward as is the measurement of a bacterial or yeast contaminant, which can be readily assessed by simply culturing a seed sample and determining whether bacterial or yeast cells grow in culture. The culture medium can be diluted further and the number of viable bacteria or yeast, which is indicative of the degree of microbial growth, can be determined by plating the dilutions on an appropriate medium and counting the resulting bacterial or yeast colonies.

Unlike bacteria and yeast, however, molds do not reproduce or grow in this fashion in most agricultural commodities, including flaxseed. The growth of molds is characterized initially by the development of mycelium. This early stage of mold growth is not visible to the unaided eye. As the mold continues to grow, this mycelium proliferates and forms a continuous and filamentous network throughout the feed. Associated with this mass is also the development of aerial mycelium that project the reproductive spores above the surface of the feed particle. This mycelial mass often becomes an integral part of the individual particles of the flaxseed being analyzed.

Traditional methodology for estimating mold growth include the “mold spore count,” which is based on the correlation between the number of mold spores in a seed sample and the level of mold growth. Mold spores occur singly or as conglomerates, and therefore can be enumerated in a manner similar to that used for the enumeration of bacteria and yeasts. The sporulation by molds and the growth of molds can, however, be independent biological events—a mold may, for example, grow abundantly in a sample of seed, but sporulate sparsely or may grow sparsely, but produce abundant spores.

Mold growth can also be measured indirectly by the disappearance of a substrate or the generation of a by-product as a result of growth of the organism. Respirometry methodology can, for example, be employed to measure microbial growth in a closed system by measuring oxygen consumption with a Warburg respirometer.

Alternatively, a “MICRO-OXYMAX” 20 (Columbus Instruments, Columbus, Ohio), which permits the simultaneous measurement of oxygen consumption and carbon dioxide generation in a “closed system.” (See, e.g., U.S. Pat. No. 4,947,339). The air in up to 20 chambers is periodically circulated through sensitive oxygen and carbon dioxide sensors and then returned to the chambers. The respirometer measures changes in gas concentrations in the chambers with respect to time. Changes in oxygen and carbon dioxide concentrations, coupled with the volume of the chamber and the time elapsed between measurements, permit the calculation of the rate at which oxygen is consumed and the rate at which carbon dioxide is produced. The cumulative consumption of oxygen and production of carbon dioxide can also be determined and used to assess the growth of the mold on the substrate.

The “MICRO-OXYMAX” 20 respirometer employs a very stable, single beam, non-dispersive, infrared carbon dioxide sensor that operates over the range of 0-1% carbon dioxide. The oxygen sensor is electrochemical (fuel cell) and has the capability of measuring directly the percentage of oxygen in the chamber atmosphere.

U.S. Pat. No. 5,648,231 discloses an improved methodology employing a “MICRO-OXYMAX” 20 respirometer for measuring mold growth on a sample by placing the sample in a container that maintains a controlled constant environment that will support rapid mold growth; maintaining the sample at a constant moisture content; initiating mold growth on the sample; and measuring the change of O₂ and/or CO₂ in the container as a measure of mold growth on the specimen.

Mycotoxin concentrations can be measured using commercially available quantitative ELISA test kits and by high performance liquid chromatography (HPLC). See, e.g., Pirestani et al., J. Res. Ag. Sci. 7(1):71-78 (2011). Mycotoxin levels in flaxseed can be determined using a competitive ELISA Procedure as provided by R-Biopharm Ag (Darmstadt, Germany), which employs a conjugated enzyme, a substrate, and a chromogen. Absorbance at 450 nm is measured as described in Rosi et al., Int. Dairy J. 17:429-435 (2007) and Sarimehmetoghlu et al., Food Control 15:45-49 (2004).

In the analytical procedures of mycotoxin analysis by HPLC, there are three steps: extraction, purification or cleaning up and quantitative determination. See, Papp et al., Microchemical J. 73:39-46 (2002). According to the ISO 1451 in 1998, samples to be tested are analyzed by using an immunochemical kit. Samples are passed through an immunoaffinity column (C18 column Supelco Discovery®). Mycotoxins are released with an extracting solution (methylacetic nitric). The eluate is injected into an HPLC system as described in Shundo and Sabino, Brazilian J. Micro. 37:164-167 (2006); Decastelli et al., Food Control 18:1263-1266 (2007); and Rosi et al., Int. Dairy J. 17:429-435 (2007). Detection level of mycotoxin is based on fluorescent character in HPLC system.

### Methodology for Assessing the Digestibility of Roasted Seed Granules and the Bioavailability of Omega-3 Fatty Acids

The digestibility of roasted seed granules and, in particular, the bioavailability of fatty acids, including omega-3 fatty acids, in roasted seed granules, including roasted flaxseed, canola seed, hemp seed, and chia seed granules, which are prepared according to the methods of the present disclosure can be evaluated by the methodology described in Cunnane et al., “High Alpha-linolenic Acid Flaxseed: Some Nutritional Properties in Humans,” British J. Nutr. 69:443-453 (1993).

Because seeds, such as flaxseed, raise α-linolenic acid and long-chain n-3 fatty acids (i.e., omega-3 fatty acids) in both plasma and erythrocyte lipids and increase levels of thiocyanate excretion, increased levels of plasma α-linolenic and long-chain n-3 fatty acids as well as in urinary thiocyanate are correlative of the bioavailability of dietary omega-3 fatty acids.

Venous blood samples can be obtained from an anticubital forearm vein before and after dietary consumption of raw seed (negative control), seed oil (positive control), and/or roasted seed granules prepared by the methods disclosed herein. Changes in plasma omega-3 fatty acid levels (e.g., 18:3n-3 levels) can be determined and compared with omega-3 fatty acid levels in equivalent amounts of raw seed, seed oil (e.g., seed oil capsules, available from Omega Nutrition, Vancouver, BC, Canada), and/or seed flour.

Plasma and erythrocyte fatty acids (EDTA-anticoagulated) can be assessed by separating plasma from the erythrocytes and dissolving the plasma in chloroform containing butylated hydroxytoluene (antioxidant; Sigma Chemical Co., St Louis, Mo.). Erythrocytes can be washed in saline and resuspended in distilled water to lyse the cells. The diluted-lysed erythrocytes can then be dissolved in methanol containing butylated hydroxytoluene and analysed.

Total lipids can be extracted into chloroform-methanol (2:1, v:v) after partitioning of the organic phase with saline. The organic phase can be dried under nitrogen gas and the phospholipid and triglyceride content of plasma and/or seed or the phosphatidylcholine and phosphatidylethanolamine of erythrocytes can be separated by thin layer chromatography as described in Cunnane, “Serum phospholipid fatty acid profiles: A possible indicator of copper status in humans,” Am. J. Clin. Nutr. 48:1475-1478 (1988).

Fatty acids in these lipid classes can be transmethylated under nitrogen using boron trifluoride in methanol (Sigma). The proportional composition of the resulting fatty acid methyl esters can be determined by gas-liquid chromatography (Hewlett-Packard 5890A) using a capillary column (Durabond 23, 30 m, 0.25 pm I.D.; J&W Scientific, Folsom, Calif.) with automated sample delivery and injection.

An increase in serum erythrocyte levels of omega-3 fatty acids (both 18:3n-3 and desaturated/elongated n-3 fatty acids) following ingestion of a roasted flaxseed granule confirms both the digestibility and the bioavailability of omega-3 fatty acids in the roasted seed granule.

### Methodology for Assessing the Flavor and Mouth Feel of Roasted and Ground Seed-Based Sources of Omega-3 Fatty Acids

Roasted seed granules, including roasted flaxseed, canola seed, hemp seed, and/or chia seed granules, which are prepared according the methods of the present disclosure and compositions containing such roasted seed granules can be assessed by qualitative factors including, but not limited to, flavor and mouth feel. As used herein, the term “mouth feel” refers to characteristics such as the apparent oiliness and/or level of “greasiness” of a roasted seed granule or composition thereof. Typically, such oiliness and/or “greasiness” is an undesirable property. It is common that as the viscosity and fineness of grind of a roasted seed is reduced to improve texture and spreadability, the visual appearance and mouth feel of the roasted seed granules and compositions become increasingly oily and/or greasy.

The viscosity of a roasted seed granule and composition thereof is affected primarily by the particle size distribution (PSD) of the ground/milled roasted seeds. Roasted seed granules, and, for example, nut butters containing roasted seed granules, which are made by milling the roasted seed granules a mono-modal particle size distribution have relatively lower viscosities. See, e.g., U.S. Pat. No. 5,079,207, which discloses roll milling of nut solids to a mono-modal particle size distribution. Conversely, a coarser grind results in a more viscous roasted flaxseed granule because the solids exist in a multi-modal (or poly-modal) particle size distribution, resulting in an increase in particle packing behavior and a greater tendency under stress of the particles to collide with each other. Another reason for the higher viscosity of poly-modal PSD roasted flaxseed granules is that coarse grinding ruptures fewer oil cells, resulting in less free oil in the roasted seed granule solid suspension.

A reduction in viscosity can be further achieved by increasing the amount of shear imparted to a roasted seed granule paste to uniformly disperse particles with the oil (referred to as work of distribution), and/or by increasing the level of added oil. A high shear mixer such as a Greerco colloid mill can be used to provide shear energy to disperse particles with the oil. U.S. Pat. No. 5,714,193 discloses the addition of oil, and is incorporated herein by reference.

Reduction in viscosity of a roasted seed granule, and composition thereof, typically leads to a reduction in flavor intensity. This is generally attributed to a reduction in the residence time in the mouth of the mass of ingested roasted seed granules, or compositions thereof. This shorter in-mouth residence time decreases the seed flavor intensity because the solids are hydrated to a lesser extent. In addition, high pressure or multiple pass homogenization often grinds the roasted seed granules to such a fine size that a significant portion of the seed flavor volatiles originally present are lost. U.S. Pat. No. 5,693,357 discloses a nut paste having a particular mono-modal particle size distribution, and U.S. Pat. No. 5,508,057 discloses a process of making mono-modal nut butters, which patents are incorporated herein by reference.

Another factor affecting consumer acceptability of roasted seed granules is the subjective impression of grittiness, which occurs when solid particles are of a sufficient size and appropriate geometry that the tongue can sense them. Solids that can impart grittiness include not only the roasted seed solids, but also other non-fat solids that are present in a composition comprising a roasted seed granule, especially water soluble solids such as sugar and salt. One way to reduce this grittiness impression is by simply passing the mixture of roasted seed granules and other non-fat solids through a high pressure homogenizer to reduce all the solids to a finer size. See U.S. Pat. No. 5,518,755 which patent is incorporated herein by reference.

Thus, one aspect of the present disclosure provides compositions that include roasted seed granules that exhibit a reduced stickiness impression; a desired roasted seed flavor intensity; a reduced grittiness impression; a desirable appearance (i.e., not an oily appearance); and has a desirable mouth feel (i.e., not a greasy mouth feel).

### Compositions Comprising Ground, Roasted Seeds

Within other embodiments the present disclosure provides compositions comprising roasted and ground seeds, including roasted and ground roast flaxseeds, canola seeds, hemp seeds, and/or chia seeds, wherein the roasting and grinding are performed according to the presently disclosed methods. Compositions provided herein are exemplified by compositions comprising roasted and ground roast seed that is produced by (1) roasting whole raw seed at suitable conditions of time and temperature to disrupt the structural integrity of the seed's seed coat and (2) grinding the roasted seed under suitable conditions of temperature and final granule size to permit the release of omega-3 fatty acids when ingested, but without causing the separation of omega-3 fatty acids, and other fatty acids, from the remainder of the seed grain.

Such compositions comprise roasted and ground seeds, including roasted and ground flaxseed, canola seed, hemp seed, and/or chia seed, roast wherein the seed was roasted at a temperature of from about 200° F. to about 400° F., or from about 225° F. to about 375° F., or from about 250° F. to about 350° F., or from about 275° F. to about 325° F. for a time of from about 1 minutes to about 7 minutes, or from about 2 minutes to about 6 minutes, or from about 3 minutes to about 5 minutes and wherein the roasted seed is ground at a temperature from about 55° F. to about 80° F., or from about 60° F. to about 75° F., or from about 65° F. to about 70° F. to a final granule size of from about 0.1 mm to about 0.6 mm, or from about 0.2 mm to about 0.5 mm, or from about 0.3 mm to about 0.4 mm.

Within certain aspects of these embodiments, the present disclosure provides compositions comprising roasted and ground flaxseed wherein the flaxseed was roasted at a temperature of from about 250° F. to about 350° F. for a time of from about 3 minutes to about 5 minutes and wherein the roasted flaxseed was ground at a temperature from about 65° F. to about 70° F. to a final granule size of from about 0.1 mm to about 0.6 mm.

Roasted seed granules, including roasted flaxseed, canola seed, hemp seed, and chia seed granules, obtained by the roasting and grinding/milling methods disclosed herein can be used directly as food ingredient or additives in foods to add flavor and nutritional values, such as in bakeries, breakfast cereals, snack foods, and ingredient for spread products (e.g., peanut butter, jams etc.). The roasted seed granules can also be further processed to produce cool-pressed seed oil and de-oiled meals. Cool-pressed seed oil is rich in omega-3 fatty acid and can be used as a salad oil and in other nutraceutical food products.

Within yet further embodiments disclosed herein are compositions comprising ground, roasted seeds wherein the roasting and grinding are performed according to the presently disclosed methods further comprising one or more food source selected from the group consisting of a nut butter or nut-containing spread, a seed butter or seed-containing spread, a vegetable oil or product containing a vegetable oil, an animal fat or a product containing an animal fat, a salad dressing, a fruit spread, a vegetable spread, a fruit and vegetable spread, a fruit- and/or a vegetable-containing beverage, such as a fruit- and/or vegetable-containing smoothy, a chocolate spread, and a food bar such as a granola bar or an energy bar.

Suitable nut butters can be selected from the group consisting of almond butter, peanut butter, cashew butter, hazelnut butter, macadamia nut butter, pecan butter, and walnut butter. Suitable seed butters can be selected from the group consisting of safflower seed butter, sunflower seed butter, pumpkin seed butter, sesame seed butter, chia seed butter, soy seed butter, chia seed butter, hempseed butter, an rapeseed butter. Suitable vegetable oils can be selected from the group consisting of peanut oil, safflower oil, sunflower oil, pumpkin seed oil, sesame seed oil, soy seed oil, chia seed oil, hempseed oil, rapeseed oil, butternut oil, pecan oil, walnut oil, hazelnut oil, almond oil, cashew oil, macadamia nut oil, corn oil, olive oil, palm oil, coconut oil, flaxseed oil, and canola oil. Suitable animal fats can be selected from the group consisting of beef fat, pork fat, poultry fat, fish fat, lard, and butter.

Nut butter and seed butter compositions may, optionally, also include one or more concentrated fruits and/or vegetables for additional nutrition. Nut butter, seed butter, and granola bar compositions may, optionally, also include one or more mixed tocopherols, flavorings, salts, and/or nutritive enhancers.

Within certain aspects of these embodiments, the present disclosure provides compositions comprising ground, roasted seeds, such as ground roasted flaxseeds, canola seeds, hemp seeds, and/or chia seeds, wherein the roasting and grinding are performed according to the presently disclosed methods further comprising one or more of a first food source selected from the group consisting of a nut butter, a vegetable oil, an animal fat, a salad dressing, and chocolate and one or more of a second food source selected from the group honey, molasses, corn syrup, cane syrup, and agave.

For example, the present disclosure provides compositions comprising from about 40% (v/v) to about 80% (v/v) of a roasted and ground seed, including a roasted and ground flaxseed, canola seed, hemp seed and/or chia seed, wherein the roasting and grinding are performed according to the presently disclosed methods; from about 10% (v/v) to about 30% (v/v) of palm oil and/or rapeseed oil; and from about 10% (v/v) to about 30% (v/v) of a food source selected from the group consisting of honey, molasses, corn syrup, cane syrup, and agave.

For example, the present disclosure provides compositions comprising from about 5% (v/v) to about 20% (v/v) of a roasted and ground seed, including a roasted and ground flaxseed, canola seed, hemp seed and/or chia seed, wherein the roasting and grinding are performed according to the presently disclosed methods; from about 5% (v/v) to about 15% (v/v) of palm oil; and from about 5% (v/v) to about 15% (v/v) of a food source selected from the group consisting of honey, molasses, corn syrup, cane syrup, and agave; and from about 50% to about 85% of a nut butter or chocolate.

Within related embodiments, the present disclosure provides compositions comprising roasted and ground seeds, including roasted and ground flaxseed, canola seed, hemp seed and/or chia seed, wherein the roasting and grinding are performed according to the presently disclosed methods, which compositions further comprise a powdered grain meal selected from the group consisting of an oat meal, a bran meal, and a corn meal; a sweetener selected from the group consisting of a sugar and a polyol; and a powder selected from the group consisting of a milk powder, a coffee powder, an instant drink powder, a chocolate powder, and a nut powder. Such nut powders can, for example, include a peanut powder, a pecan powder, a walnut powder, a hazelnut powder, an almond powder, a butternut powder, a hazelnut powder, a cashew powder and a macadamia nut powder.

For example, the present disclosure provides compositions comprising from about 15% (v/v) to about 35% (v/v) of a roasted and ground seed, including a roasted and ground flaxseed, canola seed, hemp seed and/or chia seed, wherein the roasting and grinding are performed according to the presently disclosed methods; from about 15% (v/v) to about 35% (v/v) of a powdered grain meal selected from the group consisting of oat meal, bran meal, and corn meal; from about 15% (v/v) to about 35% (v/v) of a sweetener selected from the group consisting of a sugar and a polyol; and from about 15% (v/v) to about 35% (v/v) of a powder selected from the group consisting of a milk powder, coffee powder, an instant drink powder, a chocolate powder, and a nut powder.

For example, the present disclosure provides compositions comprising about 25% (v/v) of a roasted and ground seed, including a roasted and ground flaxseed, canola seed, hemp seed and/or chia seed, wherein the roasting and grinding are performed according to the presently disclosed methods; about 25% (v/v) of oat meal; about 25% (v/v) sugar; and about 25% (v/v) of milk powder, coffee powder, instant drink powder, chocolate powder, or nut powder.

For example, the present disclosure provides compositions comprising about 25% (v/v) of a roasted and ground seed, including a roasted and ground flaxseed, canola seed, hemp seed and/or chia seed, wherein the roasting and grinding are performed according to the presently disclosed methods, and a nut powder are performed according to the presently disclosed methods; about 25% (v/v) of coffee powder; about 25% (v/v) sugar; and about 25% (v/v) of milk powder, instant drink powder, chocolate powder, or nut powder.

What is claimed is:

1. A method for producing a stabilized seed-based source of omega-3 fatty acids, said method comprising: (1) roasting a whole raw seed, said seed comprising a seed coat and a kernel that is encompassed by said seed coat, at for a time and at a temperature sufficient to disrupt the structural integrity of said seed coat but not sufficient to dissociate said seed coat from said kernel and (2) grinding the roasted seed under suitable conditions of temperature to a final granule size of from about 0.1 mm to about 0.6 mm, or from about 0.2 mm to about 0.5 mm, or from about 0.3 mm to about 0.4 mm.

2. The method of claim 1 wherein said seed is selected from the group consisting of a flaxseed, a canola seed, a hemp seed, and a chia seed.

3. The method of claim 1 wherein said raw seed is roasted at a temperature of from about 200° F. to about 400° F., or from about 225° F. to about 375° F., or from about 250° F. to about 350° F., or from about 275° F. to about 325° F.

4. The method of claim 1 wherein said raw seed is roasted for a time of from about 1 minute to about 7 minutes, or from about 2 minutes to about 6 minutes, or from about 3 minutes to about 5 minutes.

5. The method of claim 1 wherein said roasted seed is ground at a temperature from about 55° F. to about 80° F., or from about 60° F. to about 75° F., or from about 65° F. to about 70° F.

6. The method of claim 1 wherein the grind of said roasted seed enhances the digestibility of said roasted and ground seed but does not substantially cause the separation of omega-3 fatty acids, and other fatty acids.

7. A composition comprising ground, roasted seed that is produced by (1) roasting whole raw seed at suitable conditions of time and temperature to disrupt the structural integrity of the seed's seed coat and (2) grinding the roasted ground flaxseed under suitable conditions of temperature and final granule size of from about 0.1 mm to about 0.6 mm, or from about 0.2 mm to about 0.5 mm, or from about 0.3 mm to about 0.4 mm.

8. The composition of claim 7 wherein said seed is selected from the group consisting of a flaxseed, a canola seed, a hemp seed, and a chia seed.

9. The composition of claim 7 wherein said seed is roasted at a temperature of from about 200° F. to about 400° F., or from about 225° F. to about 375° F., or from about 250° F. to about 350° F., or from about 275° F. to about 325° F.

10. The composition of claim 7 wherein said seed is roasted for a time of from about 1 minute to about 7 minutes, or from about 2 minutes to about 6 minutes, or from about 3 minutes to about 5 minutes.

11. The composition of claim 7 wherein said roasted seed is ground at a temperature from about 55° F. to about 80° F., or from about 60° F. to about 75° F., or from about 65° F. to about 70° F.

12. The composition of claim 7 wherein the grind of said roasted seed enhances the digestibility of said roasted and ground seed but does not substantially cause the separation of omega-3 fatty acids, and other fatty acids.

13. A composition comprising ground, roasted seed wherein the seed was roasted at a temperature of from about 250° F. to about 350° F. for a time of from about 3 minutes to about 5 minutes and wherein the roasted flaxseed was ground at a temperature from about 65° F. to about 70° F. to a final granule size of from about 0.1 mm to about 0.6 mm.

14. The composition of claim 13, further comprising one or more food source selected from the group consisting of a nut butter, a vegetable oil, an animal fat, a salad dressing, and chocolate.

15. The composition of claim 14 wherein said nut butters is selected from the group consisting of almond butter, peanut butter, and walnut butter.

16. The composition of claim 14 wherein said vegetable oil is selected from the group consisting of peanut oil, safflower oil, corn oil, olive oil, palm and canola oil.

17. The composition of claim 14 wherein said animal fat is selected from the group consisting of beef fat, pork fat, poultry fat, lard, and butter.

18. The composition of claim 13, further comprising one or more of a first food source selected from the group consisting of a nut butter, a vegetable oil, an animal fat, a salad dressing, and chocolate and one or more of a second food source selected from the group honey, molasses, corn syrup, cane syrup, and agave.

19. A composition comprising from about 40% (v/v) to about 80% (v/v) of a ground and roasted seed wherein the roasting and grinding are performed according to the method of claim 1; from about 10% (v/v) to about 30% (v/v) of palm oil; and from about 10% (v/v) to about 30% (v/v) of a food source selected from the group consisting of honey, molasses, corn syrup, cane syrup, and agave.

20. A compositions comprising from about 5% (v/v) to about 20% (v/v) of a ground, roasted seed wherein the roasting and grinding are performed according to the method of claim 1; from about 5% (v/v) to about 15% (v/v) of palm oil and or rapeseed; and from about 5% (v/v) to about 15% (v/v) of a food source selected from the group consisting of honey, molasses, corn syrup, cane syrup, and agave; and from about 50% to about 85% of a nut butter or chocolate.

21. A composition comprising ground, roasted seed wherein the roasting and grinding are performed according to the method of claim 1, further comprising a powdered grain meal selected from the group consisting of oat meal, bran meal, and corn meal; a sweetener selected from the group consisting of a sugar and a polyol; and a powder selected from the group consisting of a milk powder, coffee powder, and almond powder.

22. A composition comprising from about 15% (v/v) to about 35% (v/v) of a ground, roasted seed wherein the roasting and grinding are performed according to the method of claim 1; from about 15% (v/v) to about 35% (v/v) of a powdered grain meal selected from the group consisting of oat meal, bran meal, and corn meal; from about 15% (v/v) to about 35% (v/v) of a sweetener selected from the group consisting of a sugar and a polyol; and from about 15% (v/v) to about 35% (v/v) of a powder selected from the group consisting of a milk powder, coffee powder, and almond powder.

23. A composition comprising about 25% (v/v) of a ground, roasted seed wherein the roasting and grinding are performed according to the method of claim 1; about 25% (v/v) of oat meal; about 25% (v/v) sugar; and about 25% (v/v) of milk powder or almond powder.

24. A composition comprising about 25% (v/v) of a ground, roasted seed wherein the roasting and grinding are performed according to the method of claim 1; about 25% (v/v) of coffee powder; about 25% (v/v) sugar; and about 25% (v/v) of milk powder or almond powder.
